(19) United States
(12) Patent Application Publication
(10) Pub. No.: US 2007/0162765 A1
(43) Pub. Date: Jul. 12, 2007

(54) Compatibility check between application and files

(75) Inventors: Maria Josephina Vincentius Engelen, Eindhoven (NL); Rudolf Theodoor Springorum, Eindhoven (NL); Petrus Christianus Franciscus Maas, Eindhoven (NL); Willem Chirstiaan Constantijn Furster, Eindhoven (NL); Mettina Harmke Zuurman, Eindhoven (NL)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS NV, Eindhoven (NL)

(21) Appl. No.: 10/596,045

(22) PCT Filed: Nov. 24, 2004
(86) PCT No.: PCT/IB04/52531

§ 371 Date: May 26, 2006

(30) Foreign Application Priority Data
Nov. 28, 2003 (EP) 03104448.0

(51) Int. Cl. H04N 7/16; G06F 12/14; H04L 9/32; G06F 17/30; G06F 11/30; G06F 7/04; G06K 9/00; H03M 1/68; H04K 1/00; H04L 9/00

(52) U.S. Cl. 713/189; 726/26

(57) ABSTRACT

The invention relates to a scintillation layer (20) for a PET-detector. The scintillation layer (20) consists of a plurality of scintillation elements (21) that are joined together in a practically gapless way and that are oriented towards the centre of curvature (24). Depending on the form of the scintillation layer (20), the scintillation elements (21) may have for example the form of a truncated wedge or pyramid.

The invention relates to a data processing system comprising a computer having a memory for storage and retrieval of at least one application program embodying a pre-determined functionality, and for storage and retrieval of at least one data-file, whereby the computer comprises a user interface for entertaining communication between the computer and a user of this computer.

Such a data processing system is in general use throughout the world.

The known data processing system usually comprises several application programs such as a word processor, a spread sheet program, a presentation program and other application programs. Each such application program requires specific types of data-files. A data-file which is usable in connection with a photo processing program does for instance not allow for processing by a word processor and vice versa.

To assist the user, the user interface of the known data processing system indicates for each application program which data-file can effectively be used thereby. In the known data processing system the feasible combinations of application programs and data-files are therefore predetermined and provided in a so-called association table, which table is based on the applicable data-file extensions. A data-file with the extension .doc may for instance relate to a document containing a string of characters representing a text that may be processed by a word processor. Such a data-file can however not be used in connection with a photo processing program.

A problem that occurs, however, is that the extension of a certain data-file may not accurately reflect its capability to be processed in connection with one or more application programs. This means that based on a given extension of a data-file its processing by an application program may prove impossible, although the user interface indicates that such combined processing is feasible. Alternatively the user interface may indicate that processing of a data-file by an application program is not feasible whereas actually such processing may prove possible. This point is particularly important because the user may alter the file extensions on his own motion so that the extension may not properly reflect the content of a data-file.

In the prior art the actual validation whether a certain application program may be combined with a certain data-file occurs immediately following the start of execution of the application program in connection with such a data-file. For that purpose the application program of the prior art comprises validation software for checking and enabling the operability of this application program in connection with the concerning data-file, whereby processing software of the application program embodying a predetermined functionality in connection with the data-file only becomes operable in dependence of same being enabled by the validation software which is executed immediately prior to the processing software. Thus, depending on the outcome of the validation software checking the compatibility of the data-file with the concerning application program, the processing software will or will not be executed in connection with such data-file.

According to the invention the application program as well as the data processing system are characterized in that the validation software is executable separately and independent from the processing software.

This provides the advantage that prior to actually executing the processing software the user interface is capable to start execution of the validation software and after completion thereof communicate a result of said execution to the user. Due to the invention the user receives accurate information about all feasible combinations of application programs and data-files that may be processed in connection with such application programs. A further advantage is that all “intelligence” that is required for selecting the said feasible combinations can remain with the designer of the application program or programs. This means that the validation software can be optimized according to the needs of the case on the one hand, and on the other hand all such application programs can run effectively under an operating system from a different designer without any need to share with the latter any knowledge pertaining to said intelligence within the validation software.

The present invention notably supports the handling of medical data such as diagnostic images and physiological data. Workflow in a hospital or at a point-of-care is made easier because the selection of application programs that can be successfully applied to data-files does not need much attention or skill from the user. Similarly, data-files that can be operated on by a selected application program are automatically selected. Hence, the user of a data-processing system or application software of the invention need not pay much attention to the handling of the medical data so that the user can spend more attention to the contents of the result of the application of the application program to the data-file. Furthermore, the user does not need to have a high level of skill in the operation of the data-processing system, as the validation software applied separately from the application program renders a higher level of intuitive operation of the data-processing system.

Further it is noted that the present invention concerns the technical mode of operation of the data-processing system of the invention (or a data processing system having the application software of the invention installed.

Advantageously the user interface is capable to start execution of the validation software and/or to start execution of the validation software immediately followed by execution of the processing software. The user interface thus not only provides the possibility that information is given about the feasible combinations of the available application programs with the available data sets. It is also possible that same is immediately followed by executing the processing software that pertains to one or more of such feasible combinations.

In one aspect of the invention the data processing system is characterized in that upon selection of an application program the user interface starts execution of the validation software of said application program in connection with all available data sets and after completion thereof communicates the data-file or data-files that are operable in connection with said application program.

In another aspect of the invention the data processing system is characterized in that upon selection of a data-file the user interface starts execution of the validation software of all available application programs and after completion thereof communicates the application program or programs that are operable in connection with said data-file.

It is preferred that the user interface has a memory for storage and retrieval of a result or results from executing the validation software. Herewith it is possible to speed up further actions which require the result(s) of the validation software, such as the start of executing the processing software.

The invention can particularly brought to advantageous use in a data processing system that is characterized in that the at least one application program and the at least one data-file relate to medical information. In such a system, especially when the medical information is medical diagnostic information the user has access to a large number of data-files wherein each data-file may contain multiple images of an organ under investigation, whilst the application programs will relate to many different clinical packages, each one offering a specific combination of viewing, processing and/or interaction capabilities targeted at obtaining a clinical diagnostic result.

In such a system the data-file or data-files may contain information derived with an apparatus selected from the group comprising MRI-, CT-, X-ray- and ultrasound-systems. With any such system medical diagnostic information may be obtained, for instance, with respect to a person's brain or a person's heart or other organs.

Without restricting the scope of invention and the claims pertaining thereto, the following description of an exemplary embodiment of the invention with reference to the annexed drawing provides a further explanation.

In the drawing:

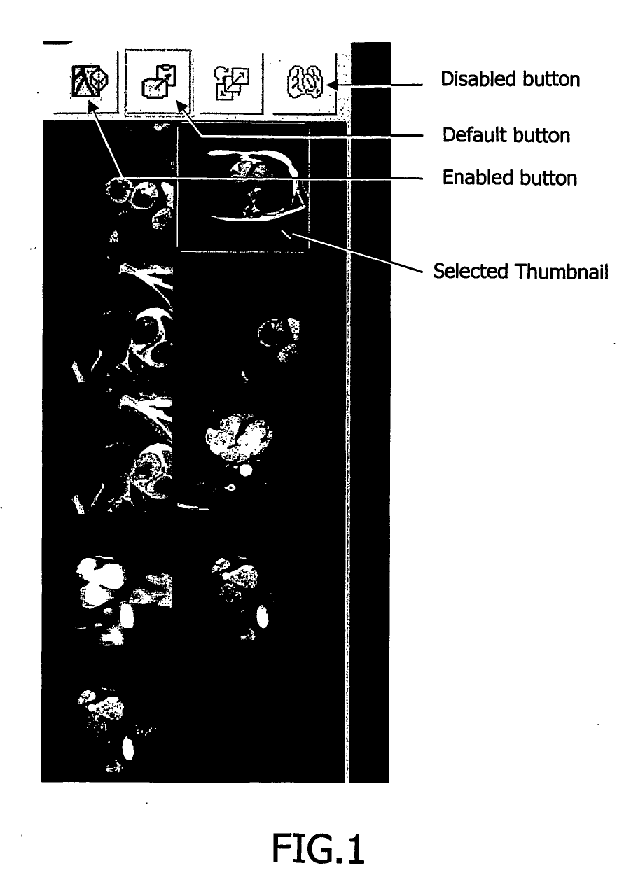

FIG. 1 shows a first screen of a visual display unit forming part of a data processing system according to the invention, and

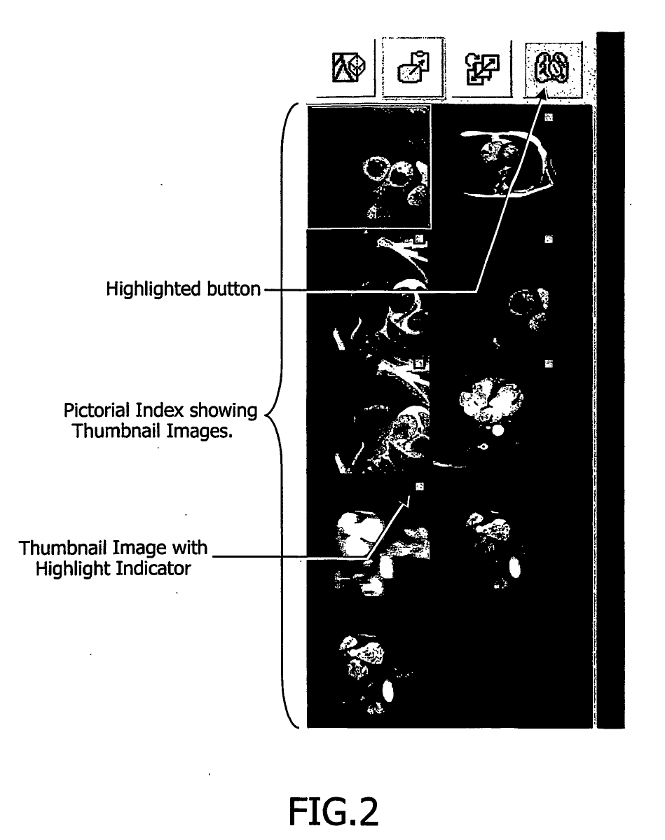

FIG. 2 shows a second screen of a visual display unit forming part of a data processing system according to the invention.

The data processing system to which the invention relates, comprises in the same way as in the prior art a computer having a memory for storage and retrieval of at least one application program embodying a predetermined functionality. The memory serves further for storage and retrieval of at least one data-file. Such known computer comprises also a user interface for entertaining communication between the computer and the user of said computer. To this end a visual display unit may be connected to the computer for making the information accessible to the user. Also a mouse or other input device, such as a key-board, may be connected to the computer allowing the user to provide information to the computer about his desired actions.

Also similar as in the prior art the application programs that are operable on the computer comprise validation software for checking and enabling the operability of these application programs in connection with the available data-files as well as processing software for executing the functionality of these application programs in connection with the applicable data-files that may become operable in dependence of a prior enablement by the validation software. This is all known prior art requiring no further elucidation.

According to the invention the validation software is executable separately and independent from the processing software allowing the user interface to start execution of the validation software whereby after completion thereof the user interface may communicate the result of this execution to the user. Examples of such results are shown in FIGS. 1 and 2, respectively.

With reference to FIG. 1 an example is shown wherein upon selection of a data-file the user interface starts execution of the validation software of all available application programs and after completion thereof communicates the application program or programs that are operable in connection with said data-file.

To this end the user selects a data-file in the shown pictorial index provided below the buttons in the top part of the VDU-screen, e.g. by mouse clicking. The selected data-file is marked by a lighted border and indicated by the words “selected thumbnail”. In the top part of the VDU-screen a series of four buttons are shown, two of which are disabled (the two rights buttons) and two of which are enabled (the two left buttons) indicating that the application programs represented by these latter two buttons can be executed in connection with the selected data-file. Actual processing may be initiated by double clicking of the selected data-file in relation to one of the application programs being assigned default or in relation to another enabled application program that the user selects.

FIG. 2 relates to a VDU-screen which is offered to the user in a data processing system according to the invention wherein upon selection of an application program the user interface starts execution of the validation software of said application program in connection with all available data sets and after completion thereof communicates the data-file or data-files that are operable in connection with said application program.

To this end the user may in a possible embodiment position a mouse such that one of the four top buttons is selected that are representative for certain predetermined application programs. Upon highlighting of the concerning button, in this example the right button, the validation software of the concerning application program is executed with respect to all available data-files represented by the pictorial index provided below the line of buttons, showing so-called “thumbnail images”. Only with those thumbnail images that are capable to be processed with the concerning application program a highlighted button occurs, in this example shown as a small square. The user may then proceed by clicking one of the highlighted data-files or dragging it to an appropriate part of the VDU-screen to initiate the actual processing software of the selected application program.

Finally it is remarked that the invention is also embodied in a data carrier which is provided with the application program according to the invention.

1. Data processing system comprising a computer having a memory for storage and retrieval of at least one application program embodying a pre-determined functionality, and for storage and retrieval of at least one data-file, which computer comprises a user interface for entertaining communication between the computer and a user of said computer, whereby the at least one application program comprises validation software for checking and enabling the operability of said application program in connection with the at least one data-file, and processing software for executing the said functionality in connection with the at least one data-file in dependence of said enabling by the validation software, wherein the validation software is executable separately and independent from the processing software.

2. Data processing system according to claim 1, wherein the user interface is capable to start execution of the validation software and after completion thereof communicate a result of said execution to the user.

3. Data processing system according to claim 1, wherein the user interface is capable to start execution of the validation software and/or to start execution of the validation software immediately followed by execution of the processing software.

4. Data processing system according to claim 1, wherein upon selection of an application program the user interface starts execution of the validation software of said application program in connection with all available data sets and after completion thereof communicates the data-file or data-files that are operable in connection with said application program.

5. Data processing system according to claim 1, wherein upon selection of a data-file the user interface starts execution of the validation software of all available application programs and after completion thereof communicates the application program or programs that are operable in connection with said data-file.

6. Data processing system according to claim 1, wherein the user interface has a memory for storage and retrieval of a result or results from executing the validation software.

7. Data processing system according to claim 1, wherein the at least one application program and the at least one data-file relate to medical information.

8. Data processing system according to claim 7, wherein the medical information is medical diagnostic information.

9. Data processing system according to claim 7, wherein the at least one data-file contains information derived with an apparatus selected from the group of MRI-, CT-, X-ray-, and ultrasound-systems.

10. Application program for use on a computer in connection with a data-file, comprising processing software embodying a pre-determined functionality, and validation software for checking and enabling the operability of said processing software in connection with said data-file, wherein the validation software is executable separately and independent from the processing software.

11. Software-carrier provided with the application program according to claim 10.
